(19) United States
(12) Patent Application Publication
(10) Pub. No.: US 2009/0063967 A1
(43) Pub. Date: Mar. 5, 2009

(54) MOBILE TERMINAL AND METHOD FOR EXECUTING APPLICATIONS THROUGH AN IDLE SCREEN THEREOF

(75) Inventors: Dong Uk LEE, Seoul (KR); Jae Joon HWANG, Seoul (KR); So Young YUN, Seoul (KR); Jung Hwa SHIM, Seoul (KR); Sang Ki LEE, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/195,562

(22) Filed: Aug. 21, 2008

(30) Foreign Application Priority Data
Sep. 4, 2007 (KR) 10-2007-0089612

(51) Int. Cl. G06F 3/041

(52) U.S. Cl. 715/702

(57) ABSTRACT

A mobile terminal having a touch screen and a method for executing applications through an idle screen thereof are disclosed. When a smart screen is called through an idle screen, it is displayed on the idle screen so as to overlap the idle screen. The smart screen displayed on the idle screen includes one of a plurality of application executing screens and a scroll bar to change the application executing screen displayed on the idle screen.

### CROSS REFERENCE TO RELATED APPLICATION

This application claims priority from and the benefit of Korean Patent Application No. 10-2007-0089612, filed on Sep. 4, 2007, which is hereby incorporated by reference for all purposes as if fully set forth herein.

### BACKGROUND OF THE INVENTION

1. Field of the Invention

The present invention relates generally to a mobile terminal and a method for executing applications through an idle screen thereof, and more particularly, to a mobile terminal and a method for executing applications through an idle screen thereof that may enable a user to promptly gain access to frequently used applications through the idle screen.

2. Discussion of the Background

In recent years, the mobile terminal market has grown very rapidly in a short time due to its new technologies and functions that stimulate consumer's interests. Due to this technological development, various applications that satisfy the needs of users, as well as simple applications, may be installed in mobile terminals. Accordingly, a user may use voice information, letter information, image information, an MP3 (MPEG layer 3), a game, etc. through a mobile terminal.

However, since several bothersome key inputs may be necessary to gain access to a desired application through a mobile terminal, a user who is not skillful in the manipulation of the mobile terminal may not be able to easily gain access to a necessary application.

Although a mobile terminal including dedicated keys to directly perform specific applications was developed in order to solve the above-mentioned problem, it may not be possible to install dedicated keys capable of performing all applications needed by a user in the mobile terminal. Furthermore, the dedicated keys in the mobile terminal may be limited to the execution of special applications, such as a digital broadcast receiver, a camera, and an MP3 player.

In addition, even though screens of display units have become wider and may have higher resolution, an idle screen of the display unit may display merely a simple fixed image, such as a photograph, an animation, or a calendar.

### SUMMARY OF THE INVENTION

The present invention provides a mobile terminal and a method that may allow for easy and prompt access to various applications through an idle screen of the mobile terminal.

The present invention also provides a mobile terminal and a method that may allow for a currently executed application to be easily changed to another application.

Additional features of the invention will be set forth in the description which follows, and in part will be apparent from the description, or may be learned by practice of the invention.

The present invention discloses a mobile phone including a touch screen and a control unit. The touch screen displays an idle screen and a smart screen to perform functions of a plurality of applications, and a selection signal by a touch is input to the touch screen. The control unit displays the smart screen on the idle screen so that the smart screen overlaps the idle screen when the smart screen is called by a touch on the idle screen. The smart screen displayed on the idle screen includes one of a plurality of application executing screens and a scroll bar to change the application executing screen displayed on the idle screen.

The present invention also discloses a method for executing applications in a mobile terminal. The method includes calling a smart screen through an idle screen, and displaying the smart screen on the idle screen so that the smart screen overlaps the idle screen. The smart screen includes one of a plurality of application executing screens and a scroll bar to change the application executing screen displayed on the idle screen.

It is to be understood that both the foregoing general description and the following detailed description are exemplary and explanatory and are intended to provide further explanation of the invention as claimed.

### BRIEF DESCRIPTION OF THE DRAWINGS

The accompanying drawing, which are included to provide a further understanding of the invention and are incorporated in and constitute a part of this specification, illustrate embodiments of the invention, and together with the description serve to explain the principles of the invention.

FIG. 1 is block diagram showing a mobile terminal having a touch screen according to an embodiment of the present invention.

FIG. 2 is an exemplary view showing an idle screen in a smart screen mode that is displayed on the touch screen of FIG. 1.

FIG. 3 is an exemplary view showing a smart screen displayed on the idle screen of FIG. 2.

FIG. 4 is a flow chart showing a method for executing applications in an idle screen of a mobile screen according to an embodiment of the present invention.

FIG. 5 is a flow chart showing a smart screen setting step of FIG. 4.

FIG. 6 and FIG. 7 are exemplary views of the smart screen setting step of FIG. 5.

FIG. 8 is a flow chart showing the smart screen mode executing step of FIG. 4.

FIG. 9 is an exemplary view of the smart screen mode executing step of FIG. 8.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

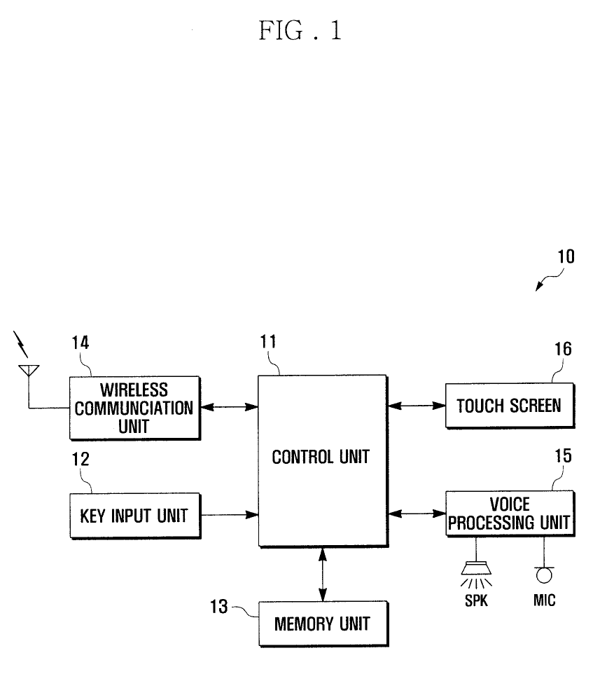

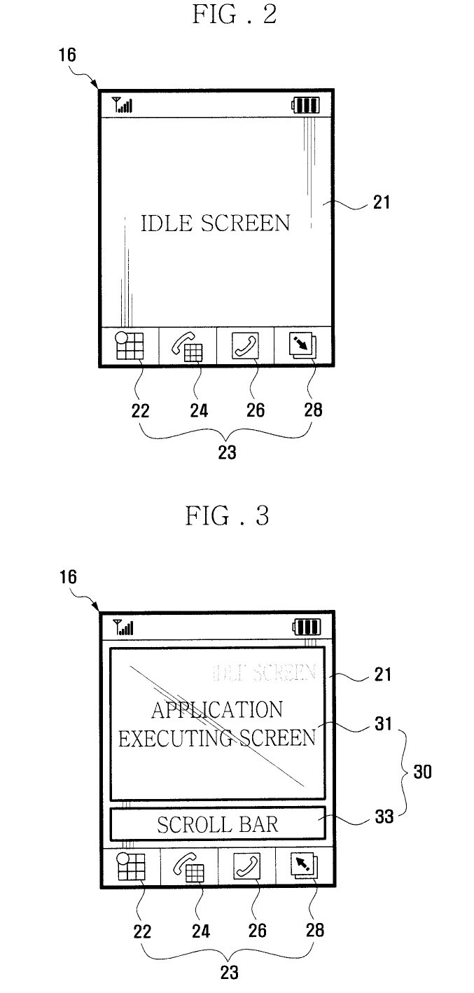

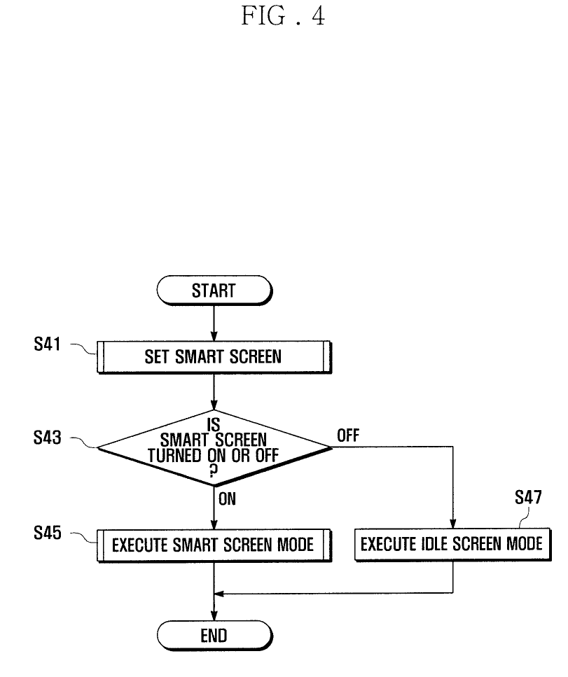

As shown in FIG. 1, FIG. 2, and FIG. 3, a mobile terminal 10 according to an exemplary embodiment of the present invention includes a control unit 11, a key input unit 12, a memory unit 13, a wireless communication unit 14, a voice processing unit 15, and a touch screen 16.

The mobile terminal 10 according to the exemplary embodiment of the present invention has a touch screen 16 and may be a mobile phone, a smart phone, a personal digital assistant (PDA), an MP3 player, a portable multimedia player (PMP), or a mobile broadcasting receiver such as a digital multimedia broadcasting (DMB) phone.

The control unit 11 is a microprocessor to control the overall operation of the mobile terminal 10. The control unit 11 controls execution of applications through an idle screen 21 using a smart screen 30.

The key input unit 12 provides a plurality of keys for manipulation of the mobile terminal and generates key data according to a selection of keys by a user and transfers the key data to the control unit 11. Instructions of a user that are generated through the key input unit 12 may include turning on/off of the mobile terminal 10, controlling the volume of the mobile terminal 10, etc.

The memory unit 13 includes a program needed to control the operation of the mobile terminal 10 and at least one volatile memory device and at least one nonvolatile memory device that store data generated during execution of the program. More particularly, the memory unit 13 stores an execution program of a smart screen mode for executing applications through the idle screen 21 and various data for executing the execution program.

The wireless communication unit 14 transmits and receives wireless communication signals for communication with other terminals. For example, the wireless communication unit 14 transmits, modulates, and frequency-changes the information output from the control unit 11 and transmits a wireless signal through an antenna. In addition, the wireless communication unit 14 separates a reception signal from wireless signals received through the antenna and frequency-changes and demodulates the reception signal to output the reception signal to the control unit 11.

The voice processing unit 15 digitalizes a voice input to a microphone MIC under the control of the control unit 11 and demodulates the voice data received through the wireless communication unit 14 and outputs them through a speaker SPK.

The touch screen 16 displays state information generated during the operation of the mobile terminal 10 and information stored in the memory unit 13. The touch screen 16 receives a selection signal generated by a touch of the screen and transfers it to the control unit 11. More particularly, the touch screen 16 displays an idle screen 21 and a smart screen 30 so that the smart screen 30 overlaps the idle screen 21.

As shown in FIG. 2 and FIG. 3, when the smart screen 30 is turned on in a smart screen setting mode, a plurality of short icons 23, including a call icon 28 for calling the smart screen 30, are displayed on the idle screen 21 together with the smart screen 30. Short icons 23 other than the call icon 28 may include a main menu icon 22, a dialed call icon 24, and a phone book icon 26 for calling and executing a main menu, a dialed call, and a phone book, respectively, but are not limited thereto. As a matter of course, when the smart screen 30 is turned off in a smart screen setting mode, the short icons 23 including the call icon 28 are not displayed on the idle screen 21.

If the smart screen 30 is called through a touch on the idle screen 21, the control unit 11 displays the smart screen 30 on the idle screen 21 so that the smart screen 30 overlaps the idle screen 21. For example, if a user touches the call icon 28 on the idle screen 21 of FIG. 2 in order to call the smart screen 30, the control unit 11 displays the smart screen 30 on the idle screen 21, as shown in FIG. 3. If the call icon 28 is touched again when the smart screen 30 is displayed, the control unit 11 eliminates the smart screen 30 on the idle screen 21 and returns to the idle screen 21 of FIG. 2. The smart screen 30 includes an application executing screen 31 for executing an application and a scroll bar 33 to change the application executing screen 31 displayed on the smart screen 30.

The control unit 11 semi-transparently displays the smart screen 30 on the idle screen 21 so that a user can confirm the information displayed at a section of the idle screen 21 below the smart screen 30. When the application executing screen 31 is displayed by a touch of the call icon 28, the control unit 11 may display the most recently used application executing screen 31 or a set application executing screen 31.

The scroll bar 33 is displayed outside the application executing screen 31, and may be disposed between the short icon 23 and the application executing screen 31. The control unit 11 allocates a plurality of applications to respective positions of the scroll bar 33, respectively. If the scroll bar 33 is touched and moved, that is, if it is dragged, the control unit 11 changes the displayed application executing screen 31 to an application executing screen 31 corresponding to the new position of the scroll bar 33. Further, if the scroll bar 33 is touched, the control unit 11 displays information of the displayed application. Then, if the scroll bar 33 is moved, the control unit 11 eliminates the information of the displayed application and displays the information of the application allocated to the new position of the scroll bar 33. Then, the information of the displayed application may be a title of the application, an icon capable of expressing the application, etc.

On the other hand, when the scroll bar 33 is touched, although the control unit 11 displays the information of the application executing screen corresponding to the position of the scroll bar 33 according to the exemplary embodiment of the present invention, it may not display the information of the application executing screen.

The control unit 11 controls the turning on/off of the smart screen 30, selection of the application that is to be executed in the idle screen 21, and the change order of the selected application according to a selection signal of a user in the smart screen setting mode. The selection signal of a user is one input to the control unit 11 by a touch through the touch screen 16 or by a selection of a dedicated key provided in the key input unit 12. Applications that can be executed through the smart screen 30 include a speed dial, a my-menu, a music player, a sketch memo, a calendar, an alarm, etc. The change order refers to position of a selected application among the plurality of applications that correspond to respective positions of the scroll bar 33. The applications whose change orders are controlled may be allocated to positions from one end of the scroll bar 33 to the other end thereof sequentially. Accordingly, if a user moves the scroll bar 33, the control unit 11 changes the application executing screen 31 according to the new position of the scroll bar 33.

Then, the smart screen 30 may enable a user to easily and promptly gain access to a frequently used application and use a frequently used basic function among functions of the application. Therefore, the function of the application executed through the smart screen 30 may be a basic function of the application, and execution of a function such as input of letters or setting of details may be performed at an application level. As a matter of course, the function performed in the smart screen 30 may be executed at the application level. Here, an application level is an environment capable of performing a function of an application in an application screen changed from the idle screen 21.

For example, basic functions of the application executed through the smart screen 30 and functions executed at an application level are described in Table 1.

TABLE 1

| | | |
|---|---|---|
| Application | Smart screen realized function | Application level realized |
| | | function |
| Speed dial | Dialed call | Setting of speed dial |
| | | (edition/deletion) |
| My-menu | Execution of application through | Setting of my-menu |
| | short key | (edition/deletion) |
| Music player | Reproduction of music and basic | Setting of music play list |
| | manipulation | |
| Sketch | Drawing sketch memo and | Sketch memo list |
| memo | sketch memo viewer | |
| Calendar | Month/week/date viewer | Drawing and editing new |
| | | schedule information |
| Alarm | Alarm viewer and setting | Setting of details of |
| | time/repetition | schedule (title, setting of |
| | | sound source) |

In the exemplary embodiment of the present invention, although it is highlighted that a user can promptly gain access to an application through the smart screen 30 to use a basic function, all functions of applications may be realized through the smart screen 30.

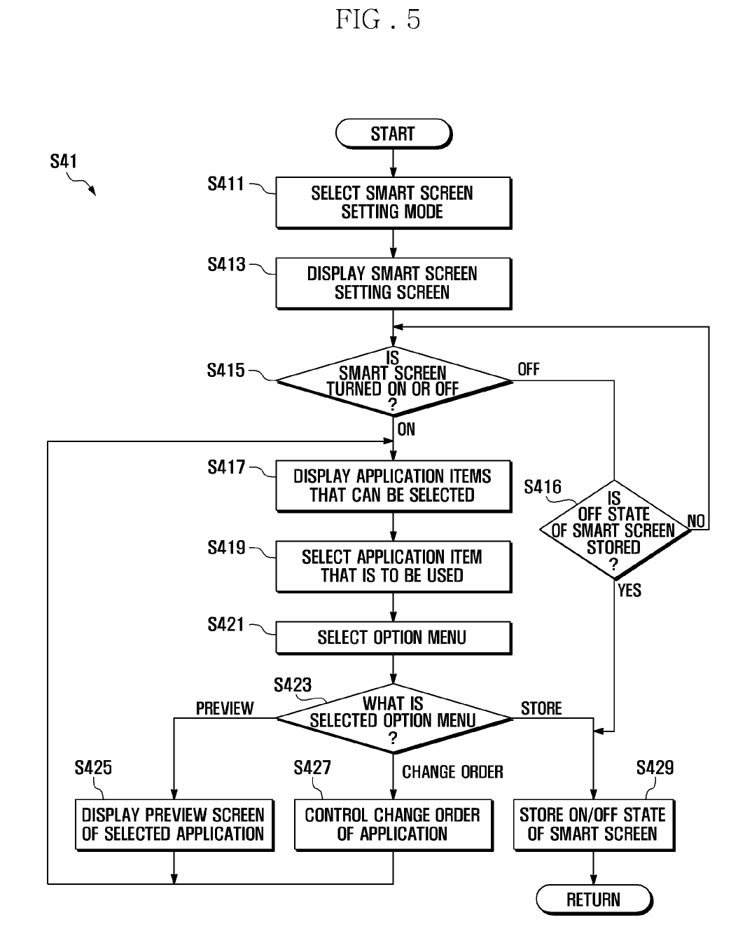

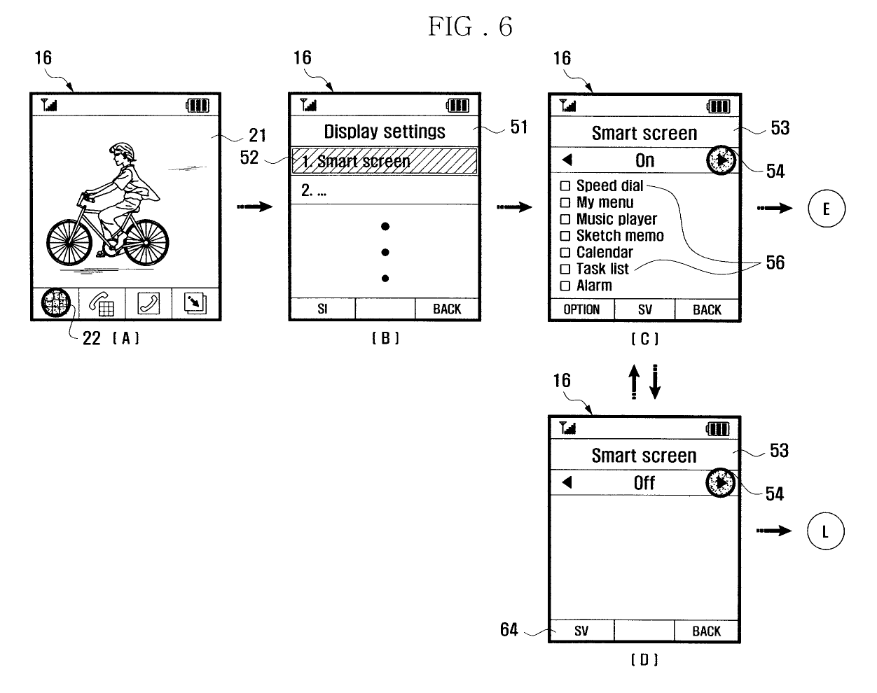

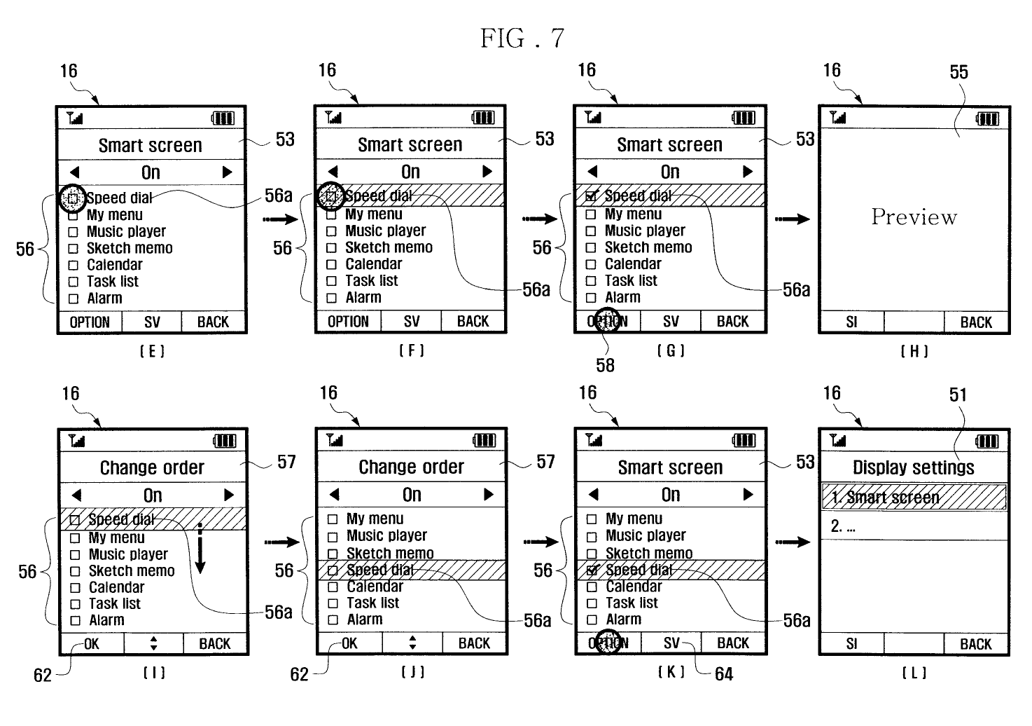

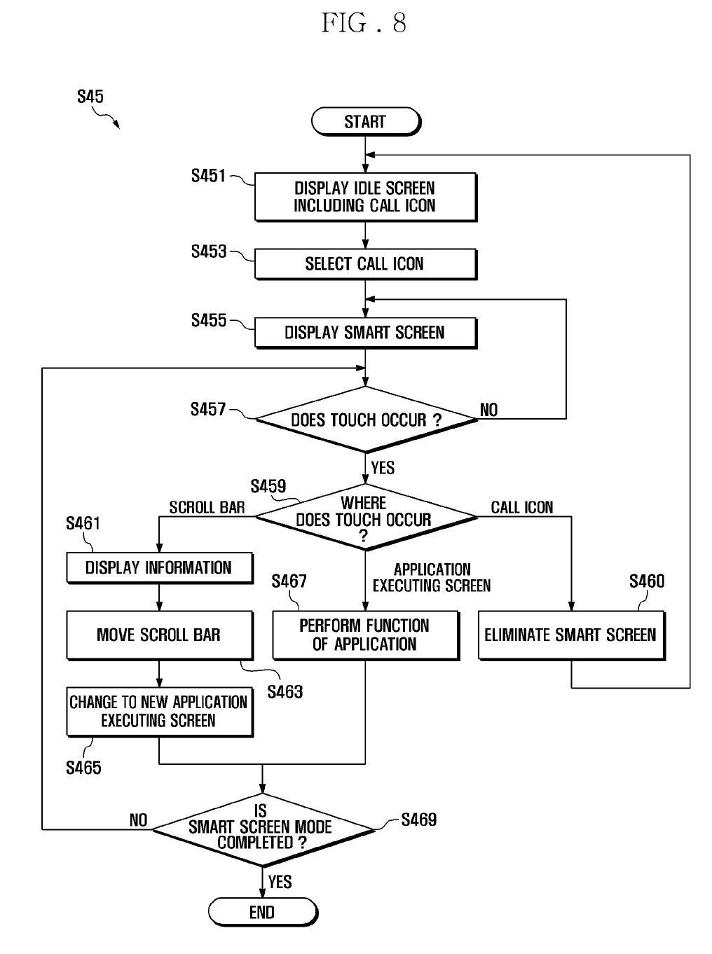

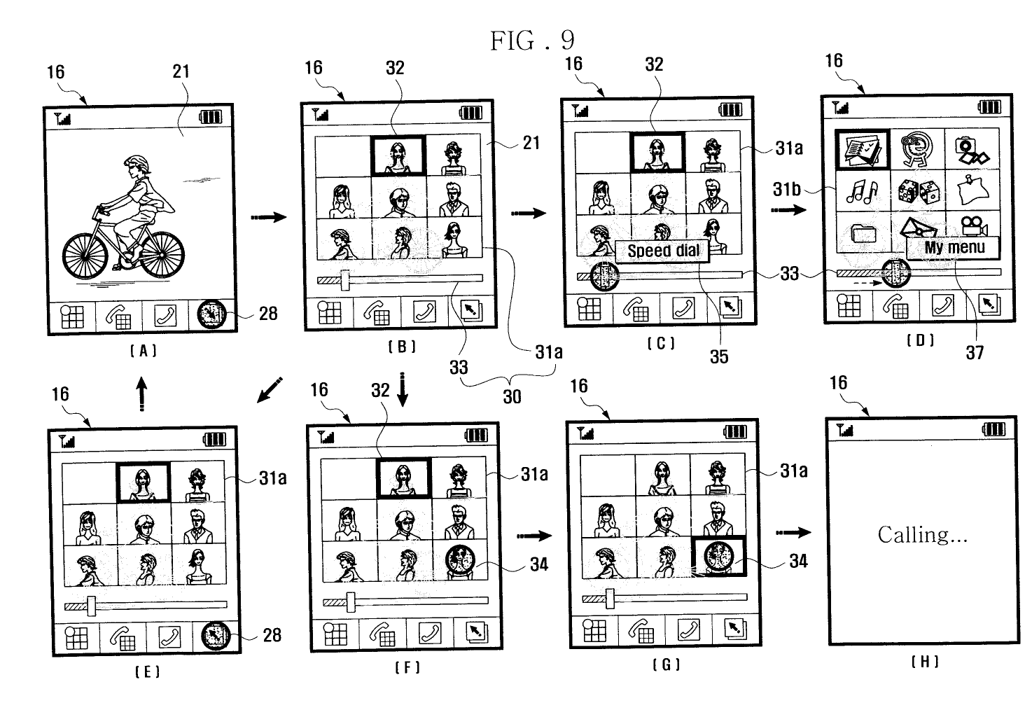

Hereinafter, a method for executing applications in the idle screen 21 of the mobile terminal 10 according to another exemplary embodiment of the present invention will be described in detail with reference to FIG. 1, FIG. 2, FIG. 3, FIG. 4, FIG. 5, FIG. 6, FIG. 7, FIG. 8, and FIG. 9. The constitution of the mobile terminal 100 will become more apparent from the following description of the application executing method.

As shown in FIG. 1, FIG. 2, FIG. 3, and FIG. 4, the application executing method according to the exemplary embodiment of the present invention starts with a step of setting a smart screen (S41). Thereafter, it is determined whether the smart screen set in step S41 is turned on or off (S43).

If the smart screen is turned on, the control unit 11 executes a smart screen mode (S45), and if the smart screen is determined to be turned off, the control unit 11 executes an idle screen mode (S47). The idle screen mode is a screen mode capable of executing functions of applications by changing the idle screen 21 to an application screen.

In the application executing method according to the exemplary embodiment of the present invention, step S41 will be described in detail with reference to FIG. 1 and FIG. 3, FIG. 4, and FIG. 5.

If the smart screen setting mode is selected through a main menu (S411), the control unit 11 displays a smart screen setting screen (S413). That is, if a menu icon 22 that is a menu displayed on the idle screen 21 is touched, the control unit 11 displays a main menu item. The main menu item includes a display setting item. If a user touches the display setting item in the main menu item, the control unit 11 displays a display setting screen including the smart screen setting item. If a user touches the smart screen setting item, the control unit 11 displays the smart screen setting screen.

Thereafter, the control unit 11 determines whether the smart screen is turned on or off (S415).

If the smart screen is turned off, the control unit 11 does not display an application item that can be selected in the smart screen setting screen. On the other hand, when the smart screen is turned off, although an example of not displaying an application item is disclosed, the present invention is not limited thereto. For example, when the smart screen is turned off, an application item may be displayed as it is and a region where the application item is displayed may be deactivated so that the application item cannot be selected through a touch or the key input unit 12. Moreover, the region where the application item is in the smart screen setting screen may be displayed transparently.

The control unit 11 determines whether the selected off state of the smart screen is to be stored (S416). If the off state of the smart screen is to be stored, the control unit 11 stores the off state of the smart screen (S429). For example, a user may store the selected off state of the smart screen through a touch of a storage key displayed on the smart screen setting screen.

On the other hand, if the on state of the smart screen is selected in S415, application items that can be selected from the smart screen setting screen are displayed (S417). The application items can be displayed in the form of texts or icons.

A user selects an application item that is to be used through a touch (S419) and then selects an option menu through a touch (S421). It is then determined what option menu has been selected (S423). Depending on the option menu selected in S421, a user may confirm a preview screen of the selected application (S425), regulate the change order thereof (S427), and store the on/off state of the smart screen including the selected application item (S429). The option menu may be selected through an option key including items such as a preview menu, a change order menu, and a storage menu, or through an individual key. Then, the option key and the individual key may be displayed on the touch screen 16 so as to be selected by a touch.

If the option key is touched in step S421, the control unit 11 displays an option menu. The option menu includes an on/off state menu, a preview menu, a change order menu, and a storage menu. The control unit 11 determines which option menu of the displayed option item is selected (S423). Here, since the screen on which a touch of the option menu occurs is the smart screen setting screen displayed by selection of the on/off state menu of the smart screen, a description of details of the case in which the on/off state menu of the smart screen is selected will be omitted.

If the preview menu is selected in step S423, the control unit 11 displays the preview screen of the focused application item of the application items (S425). The control unit 11 displays the preview screen of the focused application item since a plurality of items can be selected in the step S419.

If the change order menu is selected in step 423, the control unit 11 regulates the change order of the application item in response to a selection signal of a user (S427). For example, if a user selects one of the application items by a touch, drags it to the order in which it is to be moved, and releases the touch state, the control unit 11 displays the application item selected in the corresponding order. Then, the control unit 11 regulates the order of the other application items again in consideration of the change.

If the storage menu is selected in step S423, the control unit 11 stores the selected application item and the on/off state of the smart screen including the regulated change order of the application item (S429). Then, a display setting screen may be displayed on the touch screen 16.

Hereinafter, the smart screen setting step of S41 (see FIG. 4) will be described in detail with reference to the exemplary views of FIG. 6 and FIG. 7. If a main menu icon 22 displayed on the idle screen 21 shown in [A] of FIG. 6 is touched, the control unit 11 displays a main menu item. The main menu item includes a display setting item. If a user touches a display setting item in the main menu item, the control unit 11 displays a display setting screen 51 including a smart screen item 52 as shown in [B] of FIG. 6. If a user touches the smart screen item 52, the control unit 11 displays a smart screen setting screen 53 as shown in [C] of FIG. 6.

Then, a user selects an application item 56, that is to be used, through the smart screen setting screen 53, and selects the on/off state of the smart screen.

Thereafter, as shown in [C] of FIG. 6, selection of the on/off state of the smart screen is performed by a touch of tips 54 displayed on both sides of a region where the on/off state is to be displayed. If the smart screen item 52 is selected from the display setting screen 51 shown in [B] of FIG. 6, the control unit 11 displays the smart screen setting screen 53 on which the smart screen is displayed to be turned on as shown in [C] of FIG. 6. If the tip 54 shown in [C] of FIG. 6 is touched, the control unit 11 changes from an on state to an off state in the smart screen setting screen 54 as shown in [D] FIG. 6 to display the off state.

As shown in [C] of FIG. 6, an application item 56 in the form of a text is displayed on the smart screen setting screen 53 through which the smart screen is displayed to be turned on.

If one of the application items 56 displayed as in [E] of FIG. 7 is touched in step S419, the control unit 11 focuses the touched application item 56a as shown in [F] of FIG. 7. If the focused application item 56a is touched again, the control unit 11 selects the focused application item 56a, shown in [G] of FIG. 7, as an application that is to be used. Although an example of not selecting an application item 56 is shown in [C] of FIG. 6 and [E] of FIG. 7, conversely, all the application items 56 may be selected and displayed by default, in which case a user can release selection by touching an application item 56 that is not to be used.

Thereafter, if an option key 58 shown in [G] of FIG. 7 is touched, the control unit 11 displays an option menu. Then, if a preview menu in the option menu is selected, the control unit 11 displays a preview screen 55 of the application item 56a focused as in [H] of FIG. 7.

If the change order menu in the option menu is selected, the control unit 11 displays a change order regulating screen 57 capable of changing the order of the application item 56, as in [I] of FIG. 7. As shown in [I] and [J] of FIG. 7, the order of the application item 56 may be regulated using a touch or a direction key. That is, as shown in [I] of FIG. 7, if the speed dial item that is the focused application item 56a is touched and moved between the sketch memo item and the calendar item and then the touched state is released, the control unit 11 locates the speed dial item at the position of the sketch memo item and moves each of the my-menu item, the music player item, and the sketch memo item upward by one row as shown in [J] of FIG. 7. The order of the application item 56 is regulated by repeating the above-mentioned steps.

If a confirmation key 62 is touched after the orders are regulated, the control unit 11 returns the screen to the smart screen setting screen 53 and displays the application items 56 in the regulated orders as in [K] of FIG. 7.

If a storage key 64 or the storage menu in the option menu is selected as in [D] of FIG. 6 and [K] of FIG. 7, the control unit 11 stores the on/off state of the smart screen including the selected application item 56a, as shown in [L] of FIG. 7, and then returns the screen to the display setting screen 51.

Hereinafter, the smart screen mode executing step of S45 in the application executing method according to the exemplary embodiment of the present invention will be described in detail with reference to FIG. 1, FIG. 2, FIG. 3, and FIG. 8.

If the smart screen is turned on in the smart screen setting step of S41, the control unit 11 displays the idle screen 21 including the call icon 28 on the touch screen 16 when the idle screen 21 is displayed (S451).

Then, if the call icon 28 is selected (S453), the control unit 11 displays the smart screen 30 on the idle screen 21 (S455). Then, the application executing screen 31 displayed on the smart screen 30 may be the most recently used application executing screen or a set application executing screen. When an application executing screen set to the application executing screen 31 is displayed, the control unit 11 displays the application executing screen of the first order that has been regulated in the change order.

Thereafter, the control unit 11 determines whether a touch occurs on the touch screen 16 (S457). After the determination of the step S457, if no touch occurs, the control unit 11 maintains the display state of the smart screen 30 (S455).

If a touch occurs in step S457, the control unit 11 determines the position of the touch screen 16 where the touch occurs (S459).

After the determination of the step S459, if the call icon 460 is touched, the control unit 11 eliminates the smart screen 30 and returns the screen to the idle screen 21 (S451).

If a touch occurs on the scroll bar 33 in step S450, the control unit 11 displays the information of the currently displayed application (S461). Thereafter, if the scroll bar 33 is dragged (S463), the control unit 11 changes the displayed application executing screen 31 to a new application executing screen 31 corresponding to the new position of the scroll bar 33.

When the application executing screen 31 before the drag is converted to the application executing screen 31 after the drag, the control unit 11 changes the application executing screen 31 into a slide type corresponding to the movement speed of the scroll bar 33. Further, if at least one application is allocated between the application displayed before the drag and the application displayed after the drag, the control unit continuously changes the application executing screen 31 back and forth between the application executing screen 31 before the drag and the application executing screen 31 after the drag, in corresponding to the movement speed of the scroll bar 33 into the slide type and displays it. When the middle application executing screen 31 is located at the center of the touch screen 16, the control unit 11 displays the information of its application together.

On the other hand, if a touch occurs on the application executing screen 31 in step S459, the control unit 11 performs the function of the application linked to the touched region (S467).

After performing step S465 or step S467, the control unit 11 determines whether the smart screen mode is completed (S469). The control unit 11 can repeat steps S457 to S467 until the smart screen mode is completed.

Hereinafter, the smart screen mode executing step of S45 will be described in detail with reference to the exemplary view of FIG. 9. If the call icon 28 displayed on the idle screen 21 of [A] of FIG. 9 is touched, the control unit 11 semi-transparently displays the smart screen 30 including the application executing screen 31a and the scroll bar 33 on the idle screen 21 as in [B] of FIG. 9.

Then, the displayed application executing screen 31a (hereinafter, referred to as ‘speed dial executing screen’) is a speed dial. The speed dial executing screen 31a may be displayed in with the set speed dials arranged in a lattice. When an image is registered in the information of a counterpart that is stored in a phone book, the control unit 11 can display the speed dial in the form of a thumbnail using the registered image of the counterpart. When there is no registered image set to the speed dial in the information of the counterpart, the control unit 11 can display the phone number or name of the counterpart.

Thereafter, if the scroll bar 33 is touched as in [C] of FIG. 9, the control unit 11 displays information 35 of the displayed application. Thereafter, if the scroll bar 33 is dragged as in [D] of FIG. 9, the control unit 11 changes the screen to an application executing screen 31b corresponding to the new position of the scroll bar 33. Then, the control unit 11 displays information 37 of an application displayed above a point where the drag is completed. If the new application is a my-menu, the control unit 11 displays items in the my-menu as icons. The icons may be displayed in the form of a lattice. If the touched state is released, the information 37 of the displayed application is no longer displayed.

On the other hand, if the call icon 28 is touched again as in [E] of FIG. 9, the control unit 11 returns the screen to the idle screen 21 of [A] of FIG. 9.

If a touch occurs on the speed dial executing screen 31a, as shown in [F], [G], and [H] of FIG. 9, the control unit 11 performs the function of the speed dial linked to the touched region. That is, if the speed dial executing screen 31a is displayed as in [B] of FIG. 9, the control unit 11 focuses one of a speed dial finally performing a dialed call through the speed dial executing screen 31 a and the speed dial of the first order. The exemplary view shows that the speed dial 32 of the first order is focused.

If a predetermined speed dial 34 is touched on the speed dial executing screen 31a as in [F] of FIG. 9, the control unit 11 focuses the touched speed dial 34. Then, the touched speed dial 34 is touched again, the control unit 11 performs a dialed call to the phone number of a counterpart linked to the speed dial 34, as shown in [H] of FIG. 9.

Although the exemplary view exemplifies performing the function of the speed dial through the speed dial executing screen 31a displayed on the smart screen, the functions of applications, such as a my-menu, a music player, a sketch memo, a calendar, and an alarm, may be performed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for executing applications in a mobile terminal having a touch screen, the method comprising:
calling a smart screen through an idle screen; and
displaying the smart screen on the idle screen so that the smart screen overlaps the idle screen,
wherein the smart screen comprises one of a plurality of application executing screens and a scroll bar to change the application executing screen displayed on the idle screen.

2. The method of claim 1, wherein the smart screen is semi-transparently displayed on the idle screen when it overlaps the idle screen.

3. The method of claim 2, wherein the smart screen is called in response to a touch of a call icon displayed on the idle screen.

4. The method of claim 3, wherein the scroll bar is displayed outside the application executing screen displayed on the idle screen.

5. The method of claim 4, further comprising:
discontinuing display of the smart screen in response to a touch of the call icon while the smart screen is being displayed.

6. The method of claim 2, wherein the application executing screen of the smart screen is the most recently used application executing screen or a set application executing screen.

7. The method of claim 2, wherein the plurality of application executing screens are allocated to different positions of the scroll bar, respectively.

8. The method of claim 7, further comprising:
changing the displayed application executing screen to an application executing screen corresponding to a new position of the scroll bar when the scroll bar is touched and moved.

9. The method of claim 8, wherein information of the displayed application executing screen is displayed when the scroll bar is touched, and the information of the displayed application executing screen disappears and information of the application executing screen corresponding to the new position of the scroll bar is displayed when the scroll bar is moved.

10. The method of claim 1, further comprising:
setting the smart screen before calling the smart screen.

11. The method of claim 10, wherein setting the smart screen comprises:
selecting a plurality of application items that are to be executed through the idle screen; and
allocating the plurality of selected application items to respective positions of the scroll bar.

12. The method of claim 1, wherein the plurality of application executing screens comprise at least two of a speed dial, a my-menu, a music player, a sketch memo, a calendar, and an alarm.

13. A mobile terminal, comprising:
a touch screen to display an idle screen and a smart screen, to which a selection signal by a touch is input; and
a control unit to display the smart screen on the idle screen so that the smart screen overlaps the idle screen when the smart screen is called through a touch on the idle screen,
wherein the displayed smart screen comprises one of a plurality of application executing screens and a scroll bar to change the application executing screen displayed on the idle screen.

14. The mobile terminal of claim 13, wherein the control unit semi-transparently displays the smart screen on the idle screen.

15. The mobile terminal of claim 13, further comprising:
a call icon displayed on the idle screen,
wherein the control unit displays the smart screen when the call icon is touched, and the control unit stops displaying the smart screen from the idle screen when the call icon is touched while the smart screen is displayed.

16. The mobile terminal of claim 15, wherein the control unit displays the scroll bar outside the application executing screen displayed on the idle screen.

17. The mobile terminal of claim 14, wherein the displayed application executing screen is the most recently used application executing screen or a set application executing screen.

18. The mobile terminal of claim 14, wherein the plurality of applications are allocated to respective positions of the scroll bar, and the control unit changes the displayed application executing screen to an application executing screen allocated to a new position of the scroll bar and displays the changed application executing screen when the screen is touched and moved.

19. The mobile terminal of claim 18, wherein the control unit displays information of the displayed application executing screen when the scroll bar is touched, stops displaying the information of the displayed application executing screen when the scroll bar is moved, and displays information of the changed application executing screen corresponding to the new position of the scroll bar when the scroll bar is moved.

20. The mobile terminal of claim 13, wherein in a smart screen setting mode, the control unit selects a plurality of applications that are to be performed in the idle screen and allocates the plurality of selected applications to respective positions of the scroll bar.

21. The mobile terminal of claim 13, wherein the plurality of applications comprise at least two of a speed dial, a my-menu, a music player, a sketch memo, a calendar, an alarm, and a schedule manager.
